(19) United States
(12) Patent Application Publication
(10) Pub. No.: US 2024/0019254 A1
(43) Pub. Date: Jan. 18, 2024

(54) SPOT PROPOSAL SYSTEM AND STORAGE MEDIUM

(71) Applicant: TOYOTA JIDOSHA KABUSHIKI KAISHA, TOYOTA-SHI (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, TOYOTA-SHI (JP)

(21) Appl. No.: 18/135,351

(22) Filed: Apr. 17, 2023

(30) Foreign Application Priority Data
Jul. 12, 2022 (JP) 2022-111778

(51) Int. Cl. G01C 21/34; G01C 21/36; G06F 16/29

(52) U.S. Cl. CPC G01C 21/343; G01C 21/3694; G06F 16/29

(57) ABSTRACT

The spot proposal system includes one or more storage devices that store a database indicating a spot weather compatibility with weather tor each spot, and one or more processors, wherein the one or more processors acquire weather information for each candidate spot, acquire spot weather compatibility corresponding to the weather for each candidate spot with reference to the database, select a target spot from among the candidate spots based on the spot weather compatibility corresponding to the weather for each candidate spot, and propose a target spot to the user.

### CROSS-REFERENCE TO RELATED APPLICATION

This application claims priority to Japanese Patent Application No. 2022-111778 filed on Jul. 12, 2022, incorporated herein by reference in its entirety.

### BACKGROUND

### 1. Technical Field

The present disclosure relates to a technique for proposing a recommended spot to a user.

### 2. Description of Related Art

With the development of a car navigation system, a technique in which the car navigation system itself provides a recommended route has been developed. Conventionally, a technique in which a user sets a destination, and a car navigation system selects a route is used in most cases.

Japanese Unexamined Patent Application Publication No. 2020-134953 (JP 2020-134953 A) discloses a technique for proposing a facility suitable for a user based on needs, thoughts, characteristics, and past visit histories of the user.

### SUMMARY

In a situation where the information obtained from a user (needs, thoughts, characteristics, and past visit histories) is insufficient, it is difficult for a system to propose a spot that is recommended for the user to visit.

A first aspect relates to a spot proposal system.

The spot proposal system includes:
one or more storage devices that store a database that indicates, for each spot, spot weather compatibility that indicates compatibility with weather; and
one or more processors.

The one or more processors
acquire information on the weather for each of candidate spots,
acquire the spot weather compatibility corresponding to the weather for each of the candidate spots referring to the database,
select a target spot from among the candidate spots based on the spot weather compatibility corresponding to the weather for each of the candidate spots, and
propose the target spot to a user.

A second aspect relates to a storage medium storing a spot proposal program that causes a computer to execute processes. The processes include:
acquiring information on weather for each of candidate spots;
acquiring spot weather compatibility corresponding to the weather for each of the candidate spots referring to a database, the database indicating, for each spot, the spot weather compatibility that indicates compatibility with the weather;
selecting a target spot from among the candidate spots based on the spot weather compatibility corresponding to the weather for each of the candidate spots; and proposing the target spot to a user.

According to the present disclosure, the spot weather compatibility corresponding to the weather is acquired for each of the candidate spots. Then, the target spot is selected from among the candidate spots based on the spot weather compatibility, and the target spot is proposed to the user. Therefore, it is possible to propose the target spot even in a situation where information obtained from the use, such as needs, thoughts, characteristics, and past visit histories of the user, is insufficient. This contributes to improvement of convenience for the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an embodiment of the present disclosure;

FIG. 2 is a block diagram illustrating a configuration example of a spot proposal system according to an embodiment of the present disclosure;

FIG. 3 is a conceptual diagram illustrating an example of spot weather compatibility information and spot information;

FIG. 4 is a flowchart illustrating an example of a spot proposal method according to an embodiment of the present disclosure;

FIG. 5 is a conceptual diagram illustrating a method of extracting a candidate spot and selecting a target spot;

FIG. 6 is a diagram showing a reference point and a search range on a map;

FIG. 7 is a conceptual diagram for describing a first example of a method of extracting candidate spots;

FIG. 8 is a conceptual diagram for describing a second example of a method of extracting candidate spots;

FIG. 9 is a diagram illustrating a screen of a terminal according to the first embodiment; and

FIG. 10 is a diagram illustrating a screen of a terminal according to the second embodiment;

### DETAILED DESCRIPTION OF EMBODIMENTS

Hereinafter, embodiments of the present disclosure will be described below with reference to the drawings. In the drawings, the same or corresponding parts are denoted by the same reference numerals, and the description thereof will be simplified or omitted.

### 1. Outline of Spot Proposal System

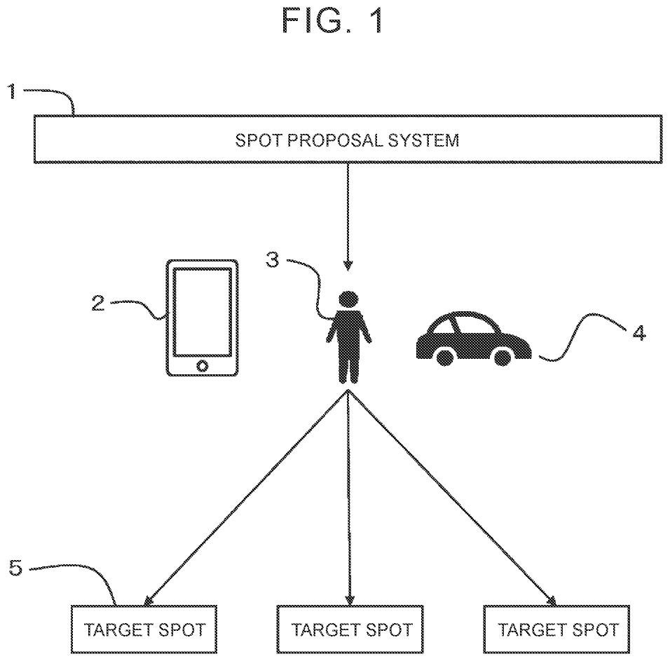

FIG. 1 shows an outline of a spot proposal system 1 according to an embodiment of the present disclosure. The spot proposal system 1 proposes a recommended spot to the user 3. Examples of the spot include a tourist site, a facility (a commercial facility, a sports facility, an art gallery, and the like), and the like. The spot proposed (presented) by the spot proposal system 1 to the user 3 is hereinafter referred to as a target spot 5.

For example, the spot proposal system 1 is included in the terminal 2 that can be operated by the user 3. Examples of the terminal 2 include a user terminal owned by the user 3, a terminal mounted on the moving means 4 used by the user 3 (for example, a navigation device), a terminal installed in a city (for example, a guidance device installed in front of a station), and the like. As another example, the spot proposal system 1 may be included in a management server capable of communicating with the terminal 2, and may provide the terminal 2 with information on the target spot 5. As yet another example, the spot proposal system 1 may be distributed between the terminal 2 and the management server.

The moving means 4 is, for example, a car. The moving means 4 may be a train, an airplane, a ship, or the like. In the present embodiment, a case where the moving means 4 is a vehicle will be described. The vehicle may be an autonomous vehicle. When the spot proposal system 1 is mounted on the autonomous vehicle, the user 3 can automatically propose the target spot 5 and automatically visit the target spot 5.

When the spot proposal system 1 proposes the target spot 5 to the user 3, weather is exemplified as an index of the proposal. In the present embodiment, the spot proposal system 1 proposes the target spot 5 using the weather as an index.

The user 3 can know the information of the target spot 5 in which the weather is considered by the proposal of the spot proposal system 1. Further, the spot proposal system 1 can propose a spot that recommends a visit automatically even when information (needs, thoughts, characteristics, and past visit history) obtained from the user 3 is small.

### 2. Structure of Spot Proposal System

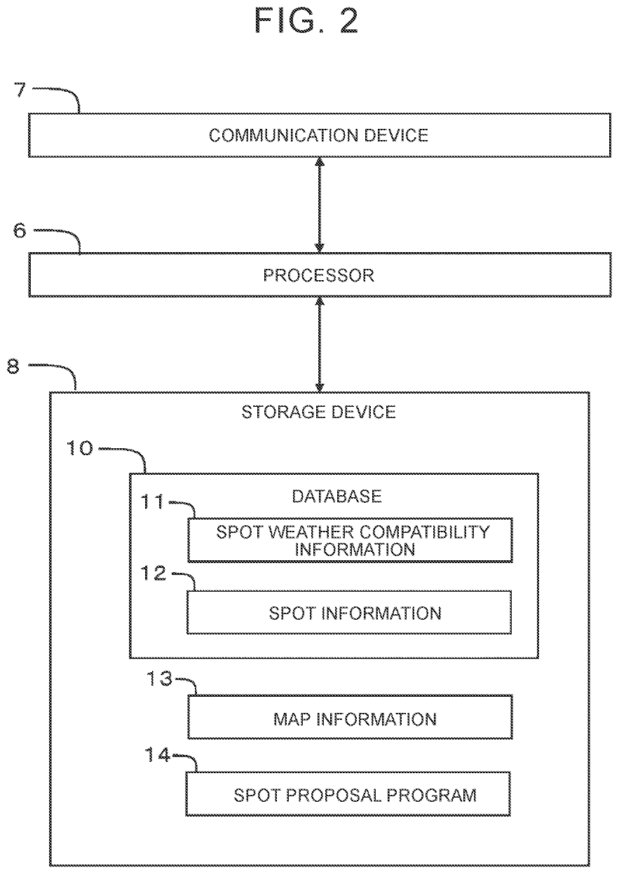

FIG. 2 is a block diagram illustrating a configuration example of the spot proposal system 1 according to the embodiment of the present disclosure. The spot proposal system 1 includes one or more processors 6 (hereinafter, simply referred to as a processor 6), a communication device 7, and one or more storage devices 8 (hereinafter, simply referred to as a storage device 8).

The processor 6 executes various processes. For example, the processor 6 includes a Central Processing Unit (CPU).

The communication device 7 communicates with the outside of the spot proposal system 1. For example, the communication device 7 communicates with a weather information service center that distributes weather information. When the spot proposal system 1 is included in the management server, the communication device 7 communicates with the terminal 2 operated by the user 3. When the spot proposal system 1 is included in the terminal 2, the communication device 7 may communicate with the management server.

The storage device 8 stores various kinds of information necessary for processing by the processor 6. Examples of the storage device 8 include volatile memory, non-volatile memory, Hard Disk Drive (HDD), Solid State Drive (SSD), and the like. The processor 6 reads various kinds of information from the storage device 8 and stores various kinds of information in the storage device 8.

The storage device 8 stores a database 10, map information 13, and a spot proposal program 14. The database 10 includes spot weather compatibility information 11 and spot information 12. The processor 6 can read out the spot weather compatibility information 11, the spot information 12, and the map information 13 in various processes. Further, the processor 6 may store the new information in the database 10.

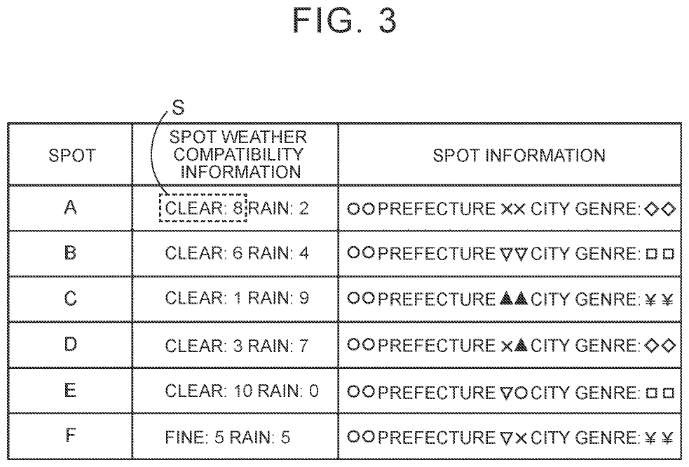

FIG. 3 shows an example of the spot weather compatibility information 11 and the spot information 12. The spot weather compatibility information 11 indicates the spot weather compatibility S for each spot. The spot weather compatibility S indicates the compatibility between the spot and the weather (e.g., sunny, cloudy, rain). Typically, the spot weather compatibility S is expressed by a numerical value for each type of weather. A high spot weather compatibility S for a certain weather means a good compatibility between the weather and the spot. Conversely, a low spot weather compatibility S for a certain weather means a poor compatibility between the weather and the spot. For example, with respect to the spot E, the spot weather compatibility S is 10 in the case of sunny weather, and the spot weather compatibility S is 0 in the case of rain. Therefore, the processor 6 determines that the spot E is recommended in the sunny weather. As another example, for spot C, the spot weather compatibility S is 1 when sunny and the spot weather compatibility S is 9 when rainy. Therefore, the processor 6 determines that the spot C is recommended in the rain.

The spot weather compatibility information 11 is generated in advance by, for example, a service provider, and is implemented in the spot proposal system 1.

The weather may be a concept including weather parameters such as temperature, humidity, wind speed, wind direction, and the like. That is, the weather may include weather parameters in addition to simple sunny rain. In this case, the spot weather compatibility S also indicates the compatibility between the spot and the weather parameter. In other words, in the spot weather compatibility information 11, the spot weather compatibility S of each spot may be determined for the air temperature, the humidity, the wind speed, the wind direction, and the like.

The spot information 12 is information about a large number of spots. For example, the spot information 12 includes position information of each spot. The location information of each spot may include an address, or may include latitude and longitude. The spot information 12 may include a genre of each spot. Examples of genres include scenic lands, historic sites, shrines and temples, museums, commercial facilities, sports facilities, and the like.

The spot proposal program 14 is a computer program in which processing necessary for proposing the target spot 5 is written. The processor 6 calls the spot proposal program 14 in the storage device 8 to propose the target spot 5 to the user 3 by executing the written process. That is, the spot proposal system 1 according to the present embodiment is realized by the cooperation of the processor 6 executing the spot proposal program 14 and the storage device 8. The spot proposal program 14 may be recorded in a computer-readable recording medium.

### 3. Spot Proposal Method

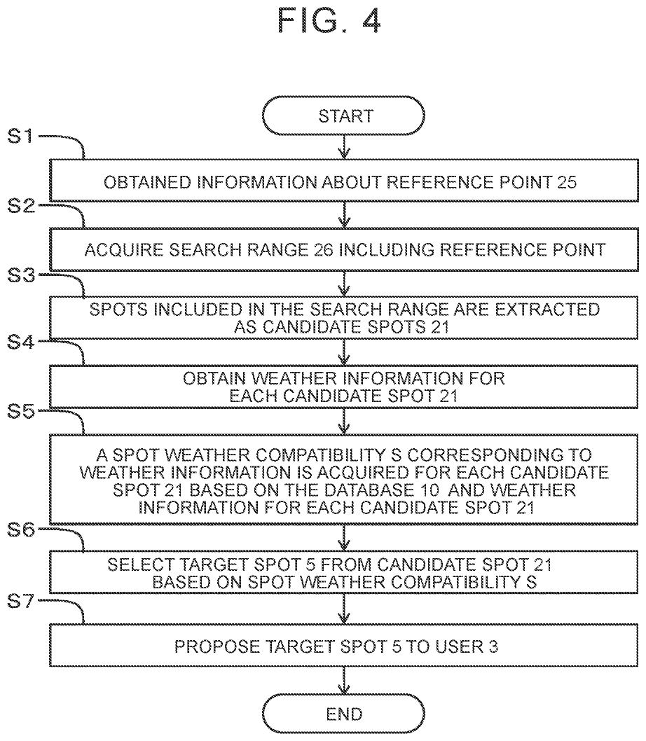

FIG. 4 is a flowchart illustrating an example of a spot proposal method according to an embodiment of the present disclosure. In the embodiment shown in FIG. 4, the spot proposal method 100 includes seven processes from step S1 to step S7.

In S1 of steps, the processor 6 acquires the reference point 25. For example, the reference point 25 is the current location of the user 3. In this case, the current location of the terminal 2 operated by the user 3 is regarded as the current location of the user 3. The terminal 2 acquires information of its current location by using Global Positioning System (GPS) or the like. The processor 6 acquires the current location of the terminal 2 as the current location of the user 3. That is, the processor 6 acquires the current location of the terminal 2 as the reference point 25. When the spot proposal system 1 is included in the management server, the processor 6 communicates with the terminal 2 via the communication device 7. Thus, the processor 6 acquires the current location of the terminal 2 as the current location of the user 3.

As another example, the reference point 25 may be any position designated by the user 3. In this case, the user 3 operates the terminal 2 to designate a desired position. For example, a map is displayed on the display screen of the terminal 2, and the user 3 designates a desired position on the displayed map. The processor 6 acquires the position designated by the user 3 as the reference point 25. When the spot proposal system 1 is included in the management server, the processor 6 communicates with the terminal 2 via the communication device 7, and acquires the position designated by the user 3 as the reference point 25.

In the following S2 of steps, the processor 6 obtains the scope including the reference point 25. The range including the reference point 25 is hereinafter referred to as a “search range 26”. For example, the search range 26 is a range that is within a certain distance from the reference point 25. As another example, the search range 26 is a range that can be reached within a certain time from the reference point 25. A predetermined distance or a predetermined time is predetermined.

As yet another example, the search range 26 may be specified by the user 3. For example, the user 3 operates the terminal 2 to specify a distance or a travel time. In this case, the search range 26 is a range existing within a specified distance from the reference point 25. Alternatively, the search range 26 is a range that can be reached within a specified travel time from the reference point 25. As another example, a map may be displayed on the display screen of the terminal 2, and the user 3 may directly designate a desired search range 26 on the displayed map. The processor 6 obtains information of the search range 26 designated by the user 3. When the spot proposal system 1 is included in the management server, the processor 6 communicates with the terminal 2 via the communication device 7, and acquires information of the search range 26 designated by the user 3.

In the following S3 of steps, the processor 6 extracts the spots included in the above-described search area 26 as “candidate spots 21”. More specifically, the spot information 12 includes position information of a large number of spots. The processor 6 refers to the position information indicated by the spot information 12, and extracts, from among the plurality of spots, those included in the search range 26 as the candidate spot 21. In other words, the processor 6 narrows down the candidate spots 21 from a large number of spots indicated by the spot information 12.

The reference point 25 and the search area 26 acquired in the above-described step S1 and step S2 may be referred to as “search conditions” for extracting the candidate spots 21. That is, the processor 6 acquires a search condition and narrows down the candidate spots 21 from a large number of spots based on the search condition and the spot information 12.

In the following S4 of steps, the processor 6 obtains the weather information in each of the candidate spots 21. The weather acquired here is, for example, the current weather. As another example, the weather acquired here may be the weather at a future time specified by the user 3. Local weather information (present state, forecast) is distributed by the weather information service center. The processor 6 communicates with the weather information service center via the communication device 7 to acquire weather information for each candidate spot 21.

In the following step S5, the processor 6 acquires the spot weather compatibility S corresponding to the weather in each of the candidate spots 21 based on the spot weather compatibility information 11 in the database 10 and the weather in each of the candidate spots 21 acquired in the step S4.

In a subsequent S6 of steps, the processor 6 selects the target spot 5 from among the candidate spots 21 based on the spot weather compatibility S corresponding to the weather of each of the candidate spots 21. More specifically, the processor 6 selects a predetermined number of candidate spots 21 as the target spots 5 in order from the ones having the higher spot weather compatibility S. The predetermined number may be designated in advance by the user 3.

In a subsequent S7 of steps, the processor 6 suggests (presents) the selected target spot 5 to the user 3. More specifically, the processor 6 instructs the terminal 2 to present the target spot 5 to the user 3. In a case where the spot proposal system 1 is included in the management server, the processor 6 communicates with the terminal 2 via the communication device 7, and provides the information of the target spot 5 to the terminal 2. The terminal 2 presents the target spot 5 to the user 3. For example, the terminal 2 includes a display device and displays information of the target spot 5 on the display device.

As described above, according to the present embodiment, the spot weather compatibility S corresponding to the weather is acquired for each candidate spot 21. Then, the target spot 5 is selected from the candidate spots 21 based on the spot weather compatibility S. Then, the target spot 5 is proposed to the user 3. Therefore, it is possible to propose the target spot 5 even in a situation where information obtained from the user 3 is insufficient, such as needs, thoughts, characteristics, and past visit histories of the user 3. This contributes to improvement of convenience for the user 3.

Further, according to the present embodiment, a target spot 5 suitable for the current or future weather is proposed to the user 3. Therefore, even in a situation where the visit of the spot originally scheduled due to the sudden change in the weather must be abandoned, the proposal of the target spot 5 is immediately made. Therefore, the user 3 can enjoy traveling and leisure without being overwhelmed.

### 4. Method of Searching, Extracting, and Selecting Spots

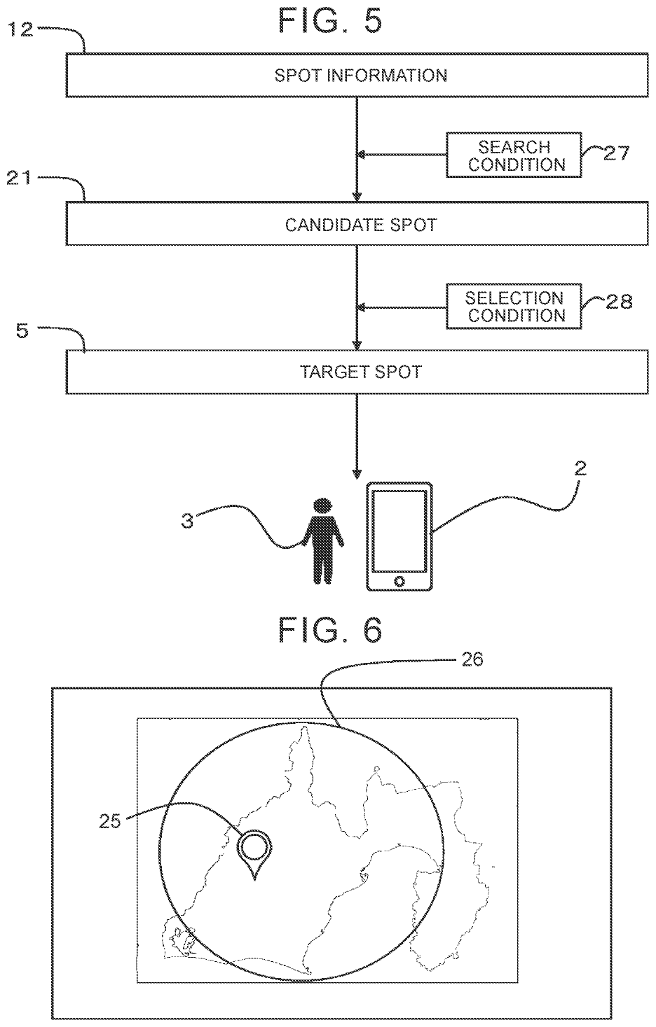

FIG. 5 is a schematic diagram illustrating a method of extracting the above-described candidate spot 21 and selecting the target spot 5. The processor 6 extracts the candidate spot 21 from the spot information 12 using the search condition 27. In other words, the processor 6 narrows down the candidate spot 21 from the spot information 12 using the search condition 27. Thereafter, the processor 6 selects the target spot 5 from the candidate spots 21 by using the selection condition 28. As described above, the selection condition 28 is the spot weather compatibility S determined for each weather in each of the candidate spots 21. Specifically, the processor 6 selects the target spot 5 in descending order of the value of S, based on the weather in each of the candidate spots 21 and the spot weather compatibility S. A plurality of target spots 5 may be selected. Further, the processor 6 may display the target spots 5 on the terminal 2 in descending order of the spot weather compatibility S of each of the target spots 5.

Specifically, a case where the processor 6 selects the target spot 5 from the candidate spot 21 in consideration of the spot weather compatibility S for each weather of each candidate spot 21 with respect to the temperature, humidity, wind speed, wind direction, and the like will be described with reference to FIG. 3 as an example. For the spot A shown in FIG. 3, consider the case where the spot weather compatibility S is 8 in the clear rain information, 8 in the air temperature, 9 in the humidity, 7 in the wind speed, and 7 in the wind direction. The processor 6 evaluates the spot A by adding up the spot weather compatibility S in all items (rain information, temperature, humidity, wind speed, and wind direction). That is, the evaluation of the spot A is 39. Further, similarly for the spot B shown in FIG. 3, a case where the spot weather compatibility S is 6 in the clear rain information, 9 in the air temperature, 10 in the humidity, 8 in the wind speed, and 8 in the wind direction will be considered. The processor 6 evaluates the spot B based on the sum of the spot weather compatibility S in all items. That is, the evaluation of the spot B is 41. The evaluation of the spot B is larger than the evaluation of the spot A. Therefore, the processor 6 determines that the spot B is a recommended spot. Therefore, the processor 6 selects the spot B as the target spot 5. As described above, the processor 6 may perform the same evaluation on each of the other candidate spots 21 in FIG. 3, and select and propose the target spot 5.

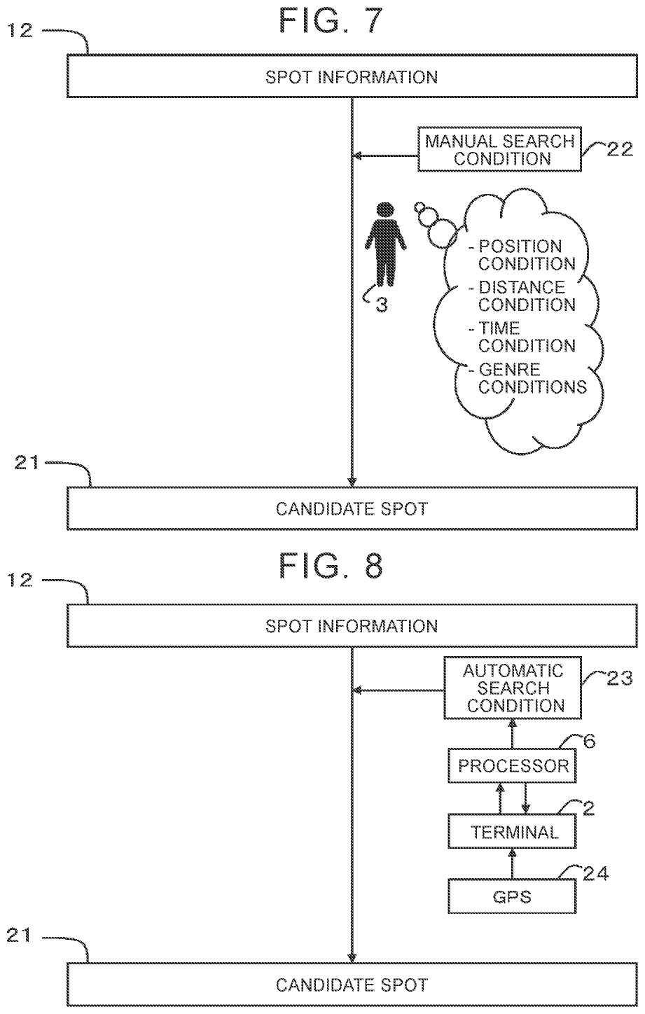

FIG. 6 is a diagram showing a reference point 25 and a search range 26 on a map. The search condition 27 will be described in detail with reference to FIG. 6. The search condition 27 is a condition for determining the search range 26 in FIG. 6. The search range 26 is a range in which the processor 6 narrows down the candidate spot 21 from the spot information 12. The processor 6 obtains the information of the reference point 25 determined by the user 3 or the processor 6, and determines the search range 26 based on the information of the reference point 25. There are two methods for determining the reference point 25 and the search range 26, and a method for determining the reference point and the search range will be described with reference to FIGS. 7 and 8.

FIG. 7 is a conceptual diagram for explaining a first example of a method of extracting candidate spots. The processor 6 extracts the candidate spot 21 from the spot information 12 using the search condition 27. Among the search conditions 27, the one in which the user 3 determines the condition as a subject is defined as the manual search condition 22. The user 3 may define the manual search condition 22 as follows. The user 3 can determine a position condition for the manual search condition 22. The position condition is a determination method of the reference point 25. For example, a current location of the user 3, a current location of the terminal 2, a point designated by the user 3, and the like are exemplified. The user 3 can then determine a distance condition or a time condition. The distance condition and the time condition are conditions for determining the search range 26 after the determination of the reference point 25. In the case of the distance condition, a range of a certain distance from the reference point 25 is set as the search range 26. The fixed distance can be specified by the user 3. In the case of the time condition, a range that can be moved within a certain time from the reference point 25 is set as the search range 26. The user 3 can specify a certain time. Finally, the user 3 can determine the genre condition. The genre condition is a condition that, for each genre of spots included in the spot information 12, only a designated genre is set as the candidate spot 21. The processor 6 extracts the candidate spot 21 from the spot information 12 using the above four conditions as the manual search condition 22 defined by the user 3.

FIG. 8 is a conceptual diagram for explaining a second example of a method of extracting candidate spots. The processor 6 extracts the candidate spot 21 from the spot information 12 using the search condition 27. Among the search conditions 27, an automatic search condition 23 is defined as one in which the processor 6 determines a condition as a subject. The automatic search condition 23 may be determined in advance by the user 3 in the following conditions. The processor 6 instructs the terminal 2 to acquire the current location of the terminal 2 using GPS 24. The terminal 2 acquires the current location data of the terminal 2 through GPS 24, and transmits the current location data to the processor 6. The processor 6 acquires the current location information of the terminal 2, and sets the current location of the terminal 2 as the reference point 25. Thereafter, the processor 6 calculates a range in which the user 3 can act, and sets the calculated range as the automatic search condition 23. The processor 6 extracts the candidate spot 21 from the spot information 12 based on the automatic search condition 23. The range in which the user 3 can act calculated by the processor 6 may be, for example, as follows. The processor 6 calculates a range in which the user 3 can act on the basis of the remaining sunshine time. The calculation method first receives the sunset time from the outside of the spot proposal system 1 (for example, the weather information service center) via the communication device 7. Next, the time from the current time to the sunset time is calculated. Next, a range of limits that can be acted on by the moving means 4 from the current position of the terminal 2 (the current position of the user 3) to the sunset time is calculated. The calculated range is set as the search range 26 and is a part of the automatic search condition 23.

### 5. Embodiment 1

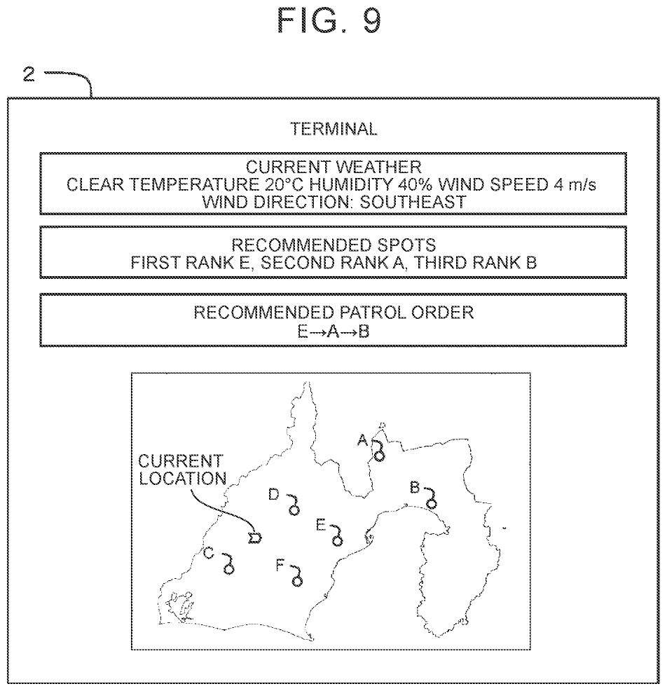

FIG. 9 is a diagram illustrating the terminal 2 according to the first embodiment. In the first embodiment, it is assumed that the target spot 5 is proposed under the conditions of sunny weather, an air temperature of 20° C., a humidity of 40%, a wind speed 4 m/s, and a wind direction of southeast. The current weather displayed on the terminal 2 is the weather at the current location of the user 3. In the first embodiment, it is assumed that the weather of each candidate spot 21 and the weather of the current location are the same. In practice, the weather of each candidate spot 21 may be different from the weather of the current location.

The processor 6 may display each of the target spots 5 in the order of the spot weather compatibility S on the terminal 2 and propose the target spots 5. The processor 6 may propose an order in which a plurality of target spots 5 are circulated, and display the order in the terminal 2. Further, the processor 6 may display the position of each of the target spots 5 on the map displayed on the terminal 2. Further, the processor 6 may display a route that circulates each of the target spots 5 on the map displayed on the terminal 2.

In the first embodiment, a case where three target spots 5 are displayed will be exemplified. First, the processor 6 narrows down six spots A to F as candidate spots 21 based on the search condition from the spot information 12. Next, the processor 6 receives weather information of each candidate spot 21 from the communication device 7 for the six candidate spots 21 from the spots A to F. The communication device 7 receives the weather information in each candidate spot 21 from the weather information service center outside the spot proposal system 1, and transmits the weather information to the processor 6. Next, the processor 6 refers to the spot weather compatibility information 11 for each candidate spot 21 from the database 10 in the storage device 8. Then, the processor 6 calculates the spot weather compatibility S based on the referenced compatibility and the current weather information.

A specific method of calculating the spot weather compatibility S will be described with reference to FIG. 3 as an example. Since the weather of each candidate spot 21 is fine, the processor 6 confirms each candidate spot 21 and the spot weather compatibility S of fine in the column of the spot weather compatibility information 11. The processor 6 proposes the target spot 5 to the user 3 in descending order of the spot weather compatibility S. In the first embodiment, the proposed target spot 5 is a spot E, a spot A. and a spot B.

The method of proposing a spot shown in the previous stage is an example, and the following method is also conceivable. For example, “all spots having a spot weather compatibility S of 7 or more are displayed. Five items are displayed in descending order of spot weather compatibility S. “For spot weather compatibility S considering not only clear rain information but also air temperature and humidity, display three in descending order of total value” or the like may be used.

The processor 6 may propose the cyclic order of the plurality of target spots 5 and propose it to the user 3. In other words, the processor 6 may determine the order of going to the plurality of target spots 5 and suggest the order of going to the plurality of target spots 5 to the user 3. When the processor 6 proposes the cyclic order of the plurality of target spots 5 to the user 3, the processor 6 displays the cyclic order on the terminal 2. In the second embodiment, the cyclic order proposed by the processor 6 is the order of the spot E, the spot A, and the spot B. The processor 6 may propose the circular order of the target spots 5 in consideration of the straight line distance from the current location and the path. Further, the processor 6 may obtain future weather information in each target spot 5 and calculate future spot weather compatibility S to propose a circulation order of the target spot 5. Further, the processor 6 may display the traveling route of the proposed target spot 5 on the map displayed on the terminal 2.

According to the present embodiment, the spot weather compatibility S corresponding to the case where the weather is clear is acquired for each candidate spot 21 (from the spot A to the spot F). Then, the target spot 5 (the spot E, the spot A, and the spot B) is proposed to the user 3 from the candidate spot 21 based on the spot weather compatibility S. Therefore, it is possible to propose the target spot 5 even in a situation where information obtained from the user 3 is insufficient, such as needs, thoughts, characteristics, and past visit histories of the user 3. This contributes to improvement of convenience for the user 3.

Further, according to the present embodiment, the spot weather compatibility S corresponding to the future weather at the time specified by the user 3 is acquired for each candidate spot 21. The processor 6 selects the target spot 5 from the candidate spots 21 based on the obtained spot weather compatibility S. The processor 6 proposes the selected target spot 5 to the user 3. Therefore, even in a situation where the visit of the spot originally scheduled due to the sudden change in the weather must be abandoned, the proposal of the target spot 5 is immediately made. Therefore, the user 3 can enjoy traveling and leisure without being overwhelmed.

### 6. Embodiment 2

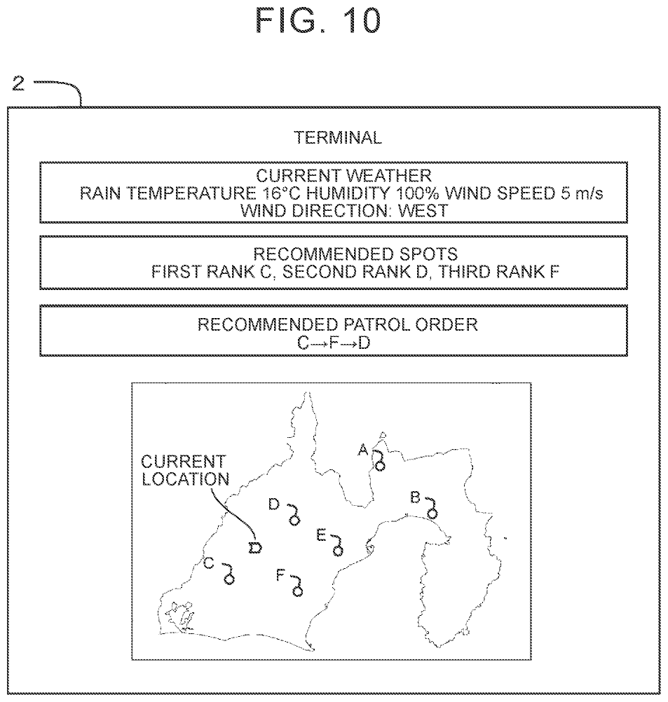

FIG. 10 is a diagram illustrating a terminal 2 according to the second embodiment. In the second embodiment, it is assumed that the target spot 5 is proposed under the conditions of rain, an air temperature of 16° C., a humidity of 100%, a wind speed m/s, and a wind direction of west. The current weather displayed on the terminal 2 is the weather at the current location of the user 3. In the second embodiment, it is assumed that the weather of each candidate spot 21 and the weather of the current location are the same. In practice, the weather of each candidate spot 21 may be different from the weather of the current location.

The processor 6 may display each of the target spots 5 in the order of the spot weather compatibility S on the terminal 2 and propose the target spots. The processor 6 may propose an order in which a plurality of target spots 5 are circulated, and display the order in the terminal 2. Further, the processor 6 may display the position of each of the target spots 5 on the map displayed on the terminal 2. Further, the processor 6 may display a route that circulates each of the target spots 5 on the map displayed on the terminal 2.

A specific method of calculating the spot weather compatibility S will be described with reference to FIG. 3 as an example. Since the weather of each candidate spot 21 is rain, the processor 6 confirms each candidate spot 21 and the spot weather compatibility S of rain in the column of the spot weather compatibility information 11. The processor 6 proposes the target spot 5 to the user 3 in descending order of the spot weather compatibility S. In the second embodiment, the proposed target spot 5 is a spot C, a spot D, and a spot F.

The method of proposing a spot shown in the previous stage is an example, and the following method is also conceivable. For example, “all spots having a spot weather compatibility S of 7 or more are displayed. Five items are displayed in descending order of spot weather compatibility S. The spot weather compatibility S considering not only the clear rain information but also the temperature and humidity is calculated and displayed in descending order by three. It may be “or the like.”

The processor 6 may propose the cyclic order of the plurality of target spots 5 and propose it to the user 3. In other words, the processor 6 may determine the order of going to the plurality of target spots 5 and suggest the order of going to the plurality of target spots 5 to the user 3. When the processor 6 proposes the cyclic order of the plurality of target spots 5 to the user 3, the processor 6 displays the cyclic order on the terminal 2. In the second embodiment, the cyclic order proposed by the processor 6 is the order of the spot C, the spot F, and the spot D. The processor 6 may propose the circular order of the target spots 5 in consideration of the straight line distance from the current location and the path. Further, the processor 6 acquires future weather information in each target spot 5, and calculates future spot weather compatibility S. Accordingly, the processor 6 may propose a cyclic order of the target spot 5. Further, the processor 6 may display the traveling route of the proposed target spot 5 on the map displayed on the terminal 2.

According to the present embodiment, the spot weather compatibility S corresponding to the case where the weather is rain is acquired for each of the candidate spots 21 (spots A to F). Then, the target spot 5 (spot C, spot D, spot F) is proposed to the user 3 from among the candidate spots 21 based oi the spot weather compatibility S. Therefore, it is possible to propose the target spot 5 even in a situation where information obtained from the user 3 is insufficient, such as needs, thoughts, characteristics, and past visit histories of the user 3. This contributes to improvement of convenience for the user 3.

Further, according to the present embodiment, the spot weather compatibility S corresponding to the future weather at the time specified by the user 3 is acquired for each candidate spot 21. The processor 6 selects the target spot 5 from the candidate spots 21 based on the obtained spot weather compatibility S. The processor 6 proposes the selected target spot 5 to the user 3. Therefore, even in a situation where the visit of the spot originally scheduled due to the sudden change in the weather must be abandoned, the proposal of the target spot 5 is immediately made. Therefore, the user 3 can enjoy traveling and leisure without being overwhelmed.

### 7. Modification

As a variant, it is conceivable that the spot proposal system 1 is mounted on an autonomous vehicle. In this case, the processor 6 reads the spot information 12 of the target spot 5 from the database 10 in the storage device 8. Thereafter, the processor 6 may transmit the read spot information 12 of the target spot 5 to the autonomous driving system in the autonomous driving vehicle. In this case, the user 3 can move to the target spot 5 only by selecting the proposed target spot 5.

1. A spot proposal system comprising:
one or more storage devices that store a database that indicates, for each spot, spot weather compatibility that indicates compatibility with weather; and
one or more processors that
acquire information on the weather for each of candidate spots,
acquire the spot weather compatibility corresponding to the weather for each of the candidate spots referring to the database,
select a target spot from among the candidate spots based on the spot weather compatibility corresponding to the weather for each of the candidate spots, and
propose the target spot to a user.

2. The spot proposal system according to claim 1, wherein:
the one or more storage devices further store spot information on a plurality of spots; and
the one or more processors further
acquire a search condition, and
narrow down the candidate spots from among the spots based on the search condition and the spot information.

3. The spot proposal system according to claim 2, wherein the search condition includes position information specified by the user or a current location of the user.

4. The spot proposal system according to claim 2, wherein the search condition includes a range in which the one or more processors narrow down the candidate spots from among the spots.

5. The spot proposal system according to claim 1, wherein the one or more processors further
determine a route to the target spot based on map information, and
propose the route to the target spot to the user.

6. The spot proposal system according to claim 5, wherein the one or more processors further display at least one of position information of the target spot and the route on a display device.

7. The spot proposal system according to claim 1, wherein when there are a plurality of the target spots, the one or more processors further
determine an order of going to the target spots, and
propose the order of going to the target spots to the user.

8. The spot proposal system according to claim 7, wherein the one or more processors determine the order of going to the target spots based on the spot weather compatibility of each of the target spots.

9. A non-transitory storage medium storing a spot proposal program that causes a computer to execute processes comprising:
acquiring information on weather for each of candidate spots;
acquiring spot weather compatibility corresponding to the weather for each of the candidate spots referring to a database, the database indicating, for each spot, the spot weather compatibility that indicates compatibility with the weather;
selecting a target spot from among the candidate spots based on the spot weather compatibility corresponding to the weather for each of the candidate spots; and
proposing the target spot to a user.
